(19) United States
(12) Patent Application Publication
(10) Pub. No.: US 2015/0178797 A1
(43) Pub. Date: Jun. 25, 2015

(54) FEEDBACK GATHERING APPARATUS, METHOD AND DEVICE

(71) Applicants: Francisco Javier ZORZANO MIER, MADRID (ES); David DEL PERAL CHICO, MADRID (ES); Laura Eva MANRIQUE LOPEZ, BARECELONA (ES)

(72) Inventors: Francisco Javier ZORZANO MIER, MADRID (ES); David DEL PERAL CHICO, MADRID (ES); Laura Eva MANRIQUE LOPEZ, BARECELONA (ES)

(73) Assignee: TELEFONICA DIGITAL ESPAÑA, S.L.U., MADRID (ES)

(21) Appl. No.: 14/140,096

(22) Filed: Dec. 24, 2013

(51) Int. Cl. G06Q 30/02

(52) U.S. Cl. CPC G06Q 30/0282

(57) ABSTRACT

An apparatus, method and device for gathering feedback information about a product (6) from a plurality of users (22) is disclosed. A feedback query about the product (6) is shown to the user (22) through a display (4) of a feedback gathering device (1) adjacent to the product (6), and the input of the user (22) regarding the query is received through a user interface (5) of the same device (1). The received user input is transmitted to external processing means (14) in the backend, where the user input is aggregated and analyzed.

### FIELD OF THE INVENTION

The present invention has its application within the telecommunications sector and, especially, in the industrial area engaged in gathering product feedback from users.

### BACKGROUND OF THE INVENTION—RELATED ART

Merchants (retail shops) and brands (manufacturers) want to obtain valuable, reliable and candid feedback from customers about their products and services in an efficient and effortless manner. However, the feedback obtained from customers is often doubtful in terms of quantity and quality, and often comprises out of context opinions. Furthermore, the process of gathering the feedback is often intrusive for customers and implies a large inversion from merchants and brands.

In the other hand, customers often do not feel sure enough about purchasing a certain product or services they see exposed in the retail store, therefore needing some additional trigger to purchase it, such as an external opinion, feedback or suggestion. Some reasons and examples about why this happens to customers are: customers plan to buy a product but once in the supermarket or in the shop they don't find it and require an alternative; customers have a high level idea of what they want, but have not settled on a particular item or brand; customers feel interest in products or services that they see in the retail but they have never purchased before.

Some approaches to gather user feedback about products and services known in the state of the art include:
Customer satisfaction surveys inside and outside retail shops with extensive data analysis. This may include online questionnaires and face to face surveys.
Customer advisory boards, which consist in meeting with a group of key customers to test ideas, gather competitive intelligence and obtain the feedback about the products and services.
Measuring customer repeated purchases, referral patterns and indicators of loyalty.
Point of sale feedback solutions integrated in the cash register.
Analytical tools of survey analysis.
Mailbox application of social suggestions that enable people to send opinions, ideas and suggestions to participating brands and merchants.
Customer comments cards in which customers write down their suggestions or complaints.

Nevertheless, all the described solutions present a number of disadvantages. Firstly, they are based on an artificial situation which makes feedback less plausible. Customer surveys and customer advisory boards are based on a series of questions built in advance and applied in out of context situations to customers that may have not experimented or processed enough in order to provide a well founded response. Secondly, customer surveys and qualitative research often imply a high economic inversion and a large infrastructure. This problem is increased when the feedback information needs to be constantly updated through periodic or continuous surveys. Thirdly, most of the questionnaires and surveys tend to be addressed in an intrusive manner to the users. Even for those customers that accept to respond and participate, the surveys are often more extensive than they expect, as well as poorly timed. Finally, customer participation lacks motivation, since it supposes an additional effort with no visible reward or profit. These factors are also detrimental to the survey sampling and to the quality of the feedback.

Furthermore, additional problems arise when managing feedback gathering systems based on multiple feedback gathering terminals. These systems present a high power consumption and require many points of access to the electrical network. Also, they typically implement a master-slave configuration, in which a central processor (master) analyzes data from multiple terminals (slaves). In this scenario, a fixed address is typically assigned to each slave during fabrication. This greatly limits the ability of the system to adapt to the connection or disconnection of terminals, as well as to manage multiple slaves of the same kind, therefore sharing the same address.

Given the disadvantages and limitations of systems known in the state of the art, there is the need of a feedback technique that gathers reliable data from the users in a contextualized and non-intrusive manner. Furthermore, there is the need of a technique that enables constant update of the user feedback in an efficient manner with limited resource consumption.

### SUMMARY OF THE INVENTION

The current invention solves the aforementioned problems by disclosing a feedback gathering system in which the quality of the data is improved by comprising a plurality of distributed devices where users can introduce feedback information about products adjacent to the devices. Efficient, non-intrusive and context-aware surveys are therefore enabled.

In a first aspect of the invention, a feedback gathering apparatus is disclosed. The apparatus comprises a plurality of feedback gathering devices, communicated with external processing means through first communication means. Each feedback gathering device is adjacent to a single product type and adapted to receive feedback queries relating only to said single product type. Each feedback gathering device, in turn, comprises a display which shows a feedback query about the single product which is adjacent to the device, as well as a user interface to receive inputs of a user regarding the feedback query. The received user inputs are transmitted to the external processing means, where they are aggregated and analyzed.

Preferably, the apparatus comprises image acquisition means which capture images of the product, as well as image recognition means which recognize the product, allowing the display to show a customized query related to the recognized product.

Also preferably, the apparatus comprises at least a screen for displaying the results of the query, and more specifically, information of the user inputs aggregated in the external processing means.

Also preferably, the first communication means between the plurality of devices and the external processing means comprise wireless communication means, such as a radio frequency link, between the devices and a hub. The hub is then connected to the external processing means through an internet transmitter. The plurality of feedback gathering devices are preferably managed through a multimaster inter integrated circuit (I2C) architecture.

The apparatus preferably comprises second communication means adapted to connect the external processing means with a user device, for example through an internet connection. More preferably, user interaction is enhanced by using the user device to transmit further feedback information of the user and/or to show aggregated feedback information to the user.

In a second aspect of the present invention, a feedback gathering device is disclosed. The feedback gathering device comprises a display to show a feedback query regarding a nearby product, as well as a user interface adapted to receive input regarding the shown query. The received input is then transmitted to external processing means through communication means comprised in the device. In a first preferred option, the display is a card holder. In a second preferred option, the display is a screen.

Preferably, the device further comprises image acquisition means which capture images of the product, providing a customized query associated to the recognized product. Image recognition is performed externally, therefore requiring the transmission of the captured images to the external processing means.

The device preferably comprises device placing means, such as a magnet, which ensure that the position of the device is fixed near the object for which the feedback query is performed.

Note that preferred options and particular embodiments disclosed for the feedback gathering apparatus can also be applied to the feedback gathering device and vice versa.

In a third aspect of the present invention, a feedback gathering method is disclosed, the method comprising the following steps:
i) Showing a feedback query to a plurality of users through displays of a plurality of feedback gathering devices. The feedback query of each device is associated to a product placed near the device.
ii) Receiving input from the plurality of users regarding the feedback query. Input is communicated to the device by means of a user interface.
iii) Transmitting the received user input to external processing means.
iv) Aggregating the user input from the plurality of feedback gathering devices. This step is performed at the external processing means, enabling further analysis and display of the aggregated user inputs.

Finally, in a fourth aspect of the present invention, a computer program is disclosed, comprising computer program code means adapted to perform the steps of the described method when said program is run on a computer, a digital signal processor, a field-programmable gate array, an application-specific integrated circuit, a micro-processor, a micro-controller, or any other form of programmable hardware. Preferred options and particular embodiments disclosed for the feedback gathering device and apparatus can also be applied to the feedback gathering method and computer program.

The disclosed method, apparatus, device and computer program provide valuable, candid and reliable feedback due to the fact that the feedback is given close to the point of the decision making process, and by voluntary customers who have previous experiences with the products and services. By using feedback tools with simple interfaces distributed along the shop, queues and non whished interruptions are prevented. Furthermore, the amount of time dedicated to providing feedback is minimized.

Gathered feedback also provides helpful information to other customers who have doubts about purchasing a product or service. Moreover, feedback is continuously updated by the customers, enabling users who have received a recommendation to validate or criticize their choice. Gathered feedback also helps vendors making decisions to adapt or improve their product choice, price, and marketing strategy, as well as to differentiate from competing merchants.

The described solution requires no extra wiring or hardware, nor any detailed continuous signal analysis. The multimaster protocol provides dynamic identifier assignment, enabling to plug in slaves without rebooting the full system, and solving power-up situations collisions. Identifiers are provided to the slaves upon connection, enabling masters to know how many slaves have been connected.

These and other advantages will be apparent with the detailed description of the invention.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a feedback gathering device according to a particular embodiment of the invention.

FIG. 2 presents an example of feedback gathering device placement.

FIG. 3 is a schematic depiction of the elements involved in the connection between the feedback gathering device and the external processing means.

FIG. 4 shows a particular embodiment of the system of the invention comprising both reactive and proactive feedback gathering devices.

FIG. 5 illustrates a particular embodiment of the system of the invention comprising product recognition features.

FIG. 6 presents a particular embodiment of the invention in which the external processing means are also connected to a user device.

FIG. 7 shows a checkout station 18 located at one or more points of sale.

FIG. 8 shows a web server 28 connected to the backend 14 which enables users 22 to provide additional feedback information through a user device 27.

### DETAILED DESCRIPTION OF THE INVENTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention. Also, description of well-known functions and elements are omitted for clarity and conciseness.

Note that in this text, the term “comprises” and its derivations (such as “comprising”, etc.) should not be understood in an excluding sense, that is, these terms should not be interpreted as excluding the possibility that what is described and defined may include further elements, steps, etc. Also note that in this text, the term “product” comprises both physical items and services offered to the customer.

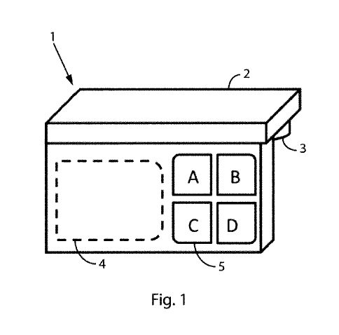

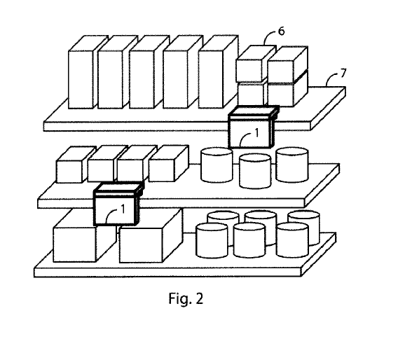

FIG. 1 shows a feedback gathering device 1, comprising a structure 2, device placing means 3, a display 4 and a user interface 5. FIG. 2 presents an example of placement of the devices 1 near products 6. In this particular case, products 6 are stored and displayed in shelves 7 of a retailer shop, such as a supermarket. The structure 2 of the device 1 is preferably built in plastic or methacrylate. A couple of strong magnets are used as placing means 3 in order to hold the structure stuck to the supermarket shelf 7.

In this case, the display 4 is a space where different cards with text and/or images can be inserted. The card displays the question of the feedback query, the possible answers and their associated buttons. The cards change with every question. When a feedback campaign ends and the next one begins, the supermarket changes the card for a new one and puts the device 1 in another shelf 7. In order to increase easiness to customers, an image or sticker of the product can be put on the card holder to better specify the product in question, facilitating customers to identify it in a simple and fast manner.

The user interface 5 comprises a plurality of buttons for inputting user feedback data, each button being associated with a possible answer of the feedback query shown by the display 4. When pressed, the buttons activate a radio transmitter that broadcasts a radio signal encoding an identifier. Each button generates a different identifier. In order to make all the feedback provision easier, questions and responses in buttons can be illustrated by icons, achieving a faster identification of questions and available responses.

Two different types of transmitters can be used, namely battery fed transmitters and energy harvesting transmitters. Battery fed transmitters employ a set of batteries to get energy, which need to be charged or changed periodically. Energy harvesting transmitters activate a small electrical generator feeding a capacitor whenever the buttons are pressed. Energy from this capacitor then goes to the radio signal generator. This kind of device does not require any battery change.

Potential customers see the feedback gathering device 1 at the same time than the products 6, that is, in the time closest to the purchase decision. The user providing feedback is in the specific grounds of the product 6 sale, whether to purchase it or not, hence providing a more reliable feedback. In addition, before purchasing a new product 6, the customers can also give first impressions feedback since it allows providing feedback in closest moment of their first encounters with the product 6.

The structure 2 of the feedback gathering device 1 is adapted in particular embodiments of the invention depending on the kind of product 6 display and the kind of store. The structure 2 can be adapted, for example, to be integrated in clothes rack, or to stand up by stands of different heights.

In order to gather different types of feedback information depending of the retail's preferences and needs, the queries of the feedback gathering device 1 are flexible and the user interface 5 can be adapted accordingly. Here are some examples of the possible feedback queries structures implemented in particular embodiments of the device:
A simple version with two predefined options (that is, an interface 5 with two buttons), such as a positive feedback and a negative feedback.
A more complete version comprising a first button for a positive feedback, a second button for negative feedback, a third button to recommend the purchase, and a fourth button to ask for recommendations.
A customized version, in which different answers are assigned to each button depending on the particular query and the particular product 6. The answer associated to each button is indicated in the display, for example, through the cards of the card holder.

In case merchants would like to ask customers for more questions, it is possible to increase the number of questions and responses in the feedback gathering device 1. Additionally, there are also other options for extending the query, such as using an interactive screen display, using an auxiliary application in a user mobile phone, and using an auxiliary web accessible from a user device.

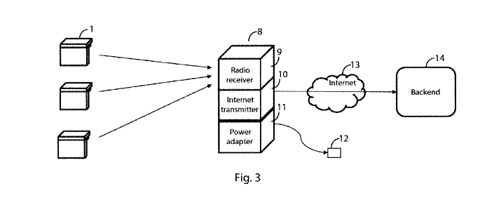

FIG. 3 shows the connection between the feedback gathering devices 1 and the processing means 14, also called backend 14. Distributed along the supermarket there are several hubs 8, each hub 8 comprising a radio receiver 9, an internet transmitter 10 and a power adapter 11. The power adapter is plugged to a power socket 12. The transmitter of each device 1 uses a low-power short-range radio signal in order to reach the nearest hub 8.

The radio receiver 9 receives radio signals from the devices 1 and sends their data to the internet transmitter 10. The Internet transmitter 10 receives data from the radio receiver 9 and transmits the data to an Internet based backend 14 service that gathers all feedback information. The connection to the backend service may be achieved through different physical connections, such as mobile network connectivity (GSM: Global System for Mobile Communications, GPRS: General Packet Radio Service, UMTS: Universal Mobile Telecommunications System, CDMA: Code division multiple access, LTE: Long Term Evolution), WiFi, Ethernet, etc. The preferred solution for connectivity on top of these transport layers is to use the TCP/IP (Transmission Control Protocol/Internet Protocol) protocol through the IP global network (i.e. Internet 13).

The power adapter 11, gets power from an alternating current power socket 12 and transform said power into a format suitable for the other modules of the hub 8. If the internet transmitter 10 uses Ethernet with a “Power on Ethernet” solution, power comes from the Ethernet link and no power adapter 11 is required.

When a company decides that feedback for a certain product 6 is needed, one or more feedback gathering devices 1 are selected in every supermarket and placed on the product shelf 7. The text card is changed in the display 4, showing the question of the feedback query and the options associated to each button. The backend 14 system is also configured, registering which feedback gathering devices 1 are to pose which question.

While a customer is picking products 6 from the shelves 7, he or she may find a feedback gathering device 1 posing a question (i.e. a feedback query about a nearby product 6). If the user wishes so, he or she may choose an answer pressing a button. At that moment, the device 1 transmits to a nearby hub 8 a device 1 identifier and a button identifier of the pressed button. The hub 8 relays this information to the backend 14 server, which records and aggregates the inputs of all users. If the same device 1 transmits two or more signals too quickly (that is, two signals are transmitted within a configurable period of time), the signals are discarded as the device 1 may be subject to improper use.

Feedback gathering devices 1 are managed by means of a multimaster I2C architecture. I2C is a widely used physical and link protocol to communicate electronic components in the same circuit board. In I2C there are two kinds of devices: masters and slaves. All feedback gathering devices 1 are connected to three lines:
GND: ground or 0 volts.
SDA: data line
SCL: clock

The I2C protocol determines mechanisms to share the bus. Masters have no identifier. Every slave has an identifier, which is a 7 bit or 10 bit number, depending on protocol version. Masters initiate communication selecting a slave, writing its address in the bus, then sending information to the slave or retrieving information from it. I2C is multimaster, allowing for several masters in the bus. At any given moment only a device can act as master.

Several methods allow to plug and unplug I2C slaves to the bus, assigning them different identifiers (ID) dynamically. One option is to configure the slave ID mechanically, through jumpers or small selectors. Users have to make sure that slave IDs are not repeated. IDs have to be introduced also in the master. In a second option, several slaves share the same ID. Slaves are intercommunicated through an extra signal following a line. When the first slave in the row communicates with the master, it tells the other slaves to block communications using the signal. When the slave finishes transmitting, it is blocked and enables the next slave to transmit (blocking the other slaves). This method requires an extra wire to communicate the slaves. In a third option, an extra wire is also used to communicate between slaves. Each slave gives information to the next slave which is used to generate its own address. In a fourth option, the continuous current voltage is used to detect the current drained by the other slaves, thus deducing how many slaves and calculating its own address. Finally, in a fifth option, switches are incorporated between the slaves. Switches are only open for communication only once the slaves before have decided on an address. These switches imply extra hardware.

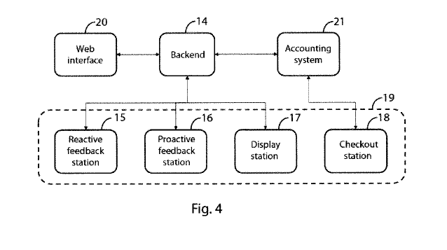

As shown in FIG. 4, the system may comprises several kinds of stations distributed in an establishment 19, such as a retail shop. Namely, the system may comprise reactive feedback stations 15, such as the feedback gathering devices based on cards previously described; proactive feedback stations 16; display stations 17; and checkout stations 18. Furthermore, the backend 14 and the checkout stations can be connected to an accounting system 21. A web interface 20 can be provided by the backend 14 in particular embodiments of the invention.

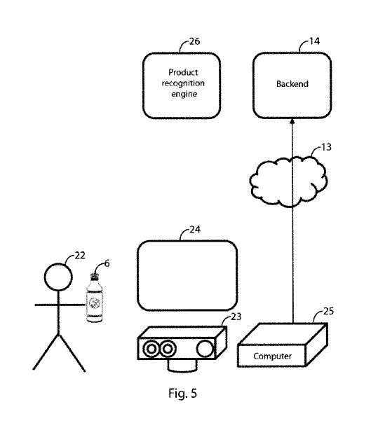

FIG. 5 shows a proactive feedback station 16, which is also a feedback gathering device 1. The proactive feedback station 16 comprises image acquisition means 23, such as a video camera, which capture images of products 6 held by a user 22 near the image acquisition means 23. Captured images are transmitted by a computer 25 to the backend 14, where they are analyzed by a product recognition engine 26. In this case, the display 4 is preferably a screen 24 showing customized feedback query for each recognized product 6.

The computer 25 is the core of the proactive feedback station and comprises a network connection to the backend 14 and the product recognition engine 26, input connection to the user interface 5, output connection to the screen 24, and specialized software running the described functions. The image acquisition means 23 may be specialized in recognizing human shapes and movements, or not specialized but supplemented by computer software able to recognize human shapes and movements. The screen 24 displays the image captured by the image acquisition means 23, giving so a mirror-like perception to customers placed in front of the screen 24. On top of this image, dialogue texts reflecting the feedback query are displayed. The product recognition engine 26 is a service that, given an image, recognizes a product 6 from a pre-existing catalogue. It can be installed as a piece of software in the computer 25 or executed in a remote server of the backend 14.

When the company decides that it wants feedback for a certain product 6 the product image is entered in the product recognition engine 26 database and the questions and possible answers are entered in the Internet Backend 14. These questions and answers may be the same or different as the ones posed in the reactive feedback stations 15. Then a customer 22 can approach the proactive feedback station 16 and show the product 6 he wants to give feedback about. The station displays to the customer 22 the questions and possible answers and receives the customer 22 answer through the interface 5. The interface 5 can be a movement detection engine, or any other interface 5 such as a set of buttons or a voice controlled interface. The customer 22 may select an open answer besides the available answer choices. In that case he or she will simply say aloud his or her opinion or type it through the interface.

When the customer shows to the proactive feedback station 16 a product 6, the proactive feedback station 16 sends the image of the product 6 to the product recognition engine 26. If the product recognition engine 26 recognizes the product 6, the product identification is sent to the backend 14. If there is a campaign on the product 6, the backend 14 sends to the proactive feedback station 16 the question and possible answers. If there is no running campaign or the product 6 is not identified, the backend 14 may produce a standard question. The proactive feedback station 16 displays to the customer 22 the question and possible answers. The customer 22, moving through the screen 24, selects one of the answers, and the proactive feedback station 16 sends the answer to the backend 14. If the customer 22 selects the open answer and gives an opinion aloud, the voice is recorded and sent to the backend 14 for later analysis.

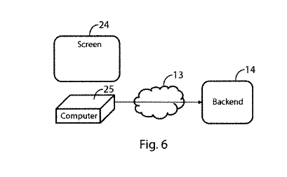

As shown in FIG. 6, a display station 17 is basically a computer 25 connected to the backend 14 and comprising a screen 24. The display station 17 may be deployed independently or as part of the proactive feedback station 16, displaying information while no customer 22 is giving feedback. The display station 17 displays publically in the supermarket the ongoing campaigns and their results, based on aggregated inputs of the users. This information gives customers 22 feedback and encourages them to participate. The display station 17 gets the information from the backend 14 through an internet connection and displays said information on the screen 24.

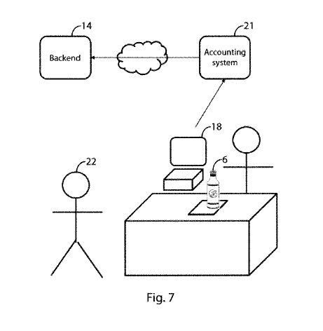

FIG. 7 shows a checkout station 18 located at one or more points of sale. The checkout stations 18 have a specialized computer that registers the so products 6 purchased by each user 22, sums up the total cost, applies discounts and generates bills. The checkout stations 18 also gather information on sales that is usually recorded and transmitted to the supermarket software systems such as accounting systems 21. Sales information are received in the backend 14 from the company accounting system 21. This information is also used as customer feedback, and incorporated to the information gathered by the reactive feedback stations 15 and proactive feedback stations 16.

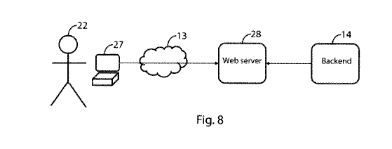

FIG. 8 shows a web server 28 connected to the backend 14 which enables users 22 to provide additional feedback information through a user device 27. The user device 27 is connected to the web server 28 by a communication network such as the internet 13. The additional feedback can be based on the same products and queries as the feedback gathering devices 1, or comprise any alternative query, also allowing customers to give feedback in a free manner. Furthermore, the web server 28 provides customer with information and results on the ongoing campaigns.

The internet backend 14 is built as a computer running specific software. The internet backend 14 may be built as a stand-alone computer or connected with other computers of the company. The backend 14 software performs the following tasks:
Receives information from the reactive feedback stations 15.
Sends information to the proactive feedback stations 16 (such as questions and answers about products 6).
Receives information from the proactive feedback stations 16.
Receives information on sales from the company accounting systems 21.
Holds information on ongoing campaigns.
Gives and receives information from the web server 28
Gathers and aggregates all the feedback information. The aggregated feedback information enables displaying the results of feedback campaigns. The aggregated feedback information also enables company analysts taking decisions based on them, or sell this so information to other manufacturers and providers.

The feedback information gathered at the feedback gathering devices 1 and aggregated at the backend 14 is addressed to both retails companies and customers 22. Customers 22 can access the aggregated data through the display stations 16, mobile phone apps and web pages. Thus, customers 22 gain insight on the opinions of the rest of customers 22, can compare results, as well as iterate on the basis of what has been expressed. Other people's feedback hence becomes a help or catalyst for those customers 22 that where hesitant about whether to buy or not some products or services. In the other hand, retails and business obtain candid feedback that helps them to make decisions about products and services they offer as well as to improve them in a simple and cheap way without annoying their customers.

The approach of candid feedback is guaranteed by the fact that it has been provided in the same context and time of the purchase decision, by customers who have come to the specific store, and who participate voluntarily in the feedback gathering.

In order to gather additional feedback information, it is possible to write down more open information about the products thanks to the web and the app. In both the web and the app, the only thing that customers have to do is access, select the product, and either write any comment they want, or press a button if a closed set of responses is provided. In the same way, customers that want to access the opinions and comments of other customers can access, select, read comments and iterate if necessary by writing down specific questions they need to solve.

The proposed apparatus, method, device and computer program benefit retails and businesses in achieving highly accurate feedback information about their products and services, helping them analysing and making strategic decisions about their products, as well as what to offer to other interested stakeholders as brands factories and suppliers.

1. A feedback gathering apparatus characterized in that the apparatus comprises:
a plurality of feedback gathering devices (1), each feedback gathering device (1) being adjacent to a single product (6) type and adapted to receive feedback queries relating only to the single product (6) type, and each feedback gathering device (1) comprising:
a display (4) adapted to show the received feedback queries,
a user interface (5) adapted to receive input from a user (22) regarding the feedback queries;
external processing means (14) adapted to receive and aggregate the user inputs from the plurality of feedback gathering devices (1);
first communication means adapted to communicate the at least one feedback gathering device (1) with the external processing means (14).

2. The apparatus according to claim 1 further comprising image acquisition means (23) adapted to capture an image of a product (6) and image recognition means (26) adapted to recognize the product (6) in the image.

3. The apparatus according to claim 1 further comprising at least a screen (24) connected to the external processing means (14), being the at last one screen (24) adapted to display the user inputs aggregated by the external processing means.

4. The apparatus according to claim 1 wherein the first communication means comprise wireless communication means (9) adapted to connect the plurality of feedback gathering devices (1) to a hub (8) and an internet transmitter (10) adapted to connect the hub (8) and the external processing means (14).

5. The apparatus according to claim 1 wherein the plurality of feedback gathering devices (1) are managed through a multimaster inter integrated circuit architecture.

6. The apparatus according to claim 1, further comprising second communication means adapted to connect the external processing means (9) and a user device (27).

7. The apparatus according to claim 6 wherein the external processing means (14) are further adapted to receive additional feedback information from the user device (27).

8. The apparatus according to claim 7 wherein the external processing means (14) are further adapted to transmit to the user device (27) information of the aggregated user input from the plurality of feedback devices (1).

9. A feedback gathering device (1), characterised in that the device comprises:
a display (4) adapted to show a feedback query regarding a product (6) adjacent to the feedback gathering device (1);
a user interface (5) adapted to receive input from a user (22) regarding the feedback query;
and communication means adapted to send the received user input to external processing means (14).

10. The device (1) according to claim 9, further comprising image acquisition means (23) adapted to capture an image of a product (6) and to send the captured image to image recognition means (26).

11. The device (1) according to claim 9 further comprising device placing means (3) adapted to fix the position of the device (1) near the product (6).

12. The device (1) according to claim 9 wherein the display (4) is a card holder.

13. The device (1) according to claim 9 wherein the display (4) is a screen (24).

14. A method of feedback gathering characterized in that the method comprises:
showing a feedback query to a plurality of users (22) through displays (4) of a plurality of feedback gathering devices (1) regarding products (6) adjacent to the plurality of feedback gathering devices (1);
receiving input from the plurality of user (22) through user interfaces (5) of the feedback gathering devices (1) regarding the feedback query;
transmitting the received user input to external processing means (14);
aggregating the user input from the plurality of feedback gathering devices (1).

15. A digital data storage medium storing a computer program product comprising instructions causing a computer executing the program, to perform all steps of a method according to claim 14.

16. The apparatus according to claim 2 further comprising at least a screen (24) connected to the external processing means (14), being the at last one screen (24) adapted to display the user inputs aggregated by the external processing means.

17. The apparatus according to claim 16 wherein the first communication means comprise wireless communication means (9) adapted to connect the plurality of feedback gathering devices (1) to a hub (B) and an internet transmitter (10) adapted to connect the hub (8) and the external processing means (14).

18. The apparatus according to claim 17 wherein the plurality of feedback gathering devices (1) are managed through a multimaster inter integrated circuit architecture.

19. The apparatus according to claim 18, further comprising second communication means adapted to connect the external processing means (9) and a user device (27).

20. The apparatus according to claim 19 wherein the external processing means (14) are further adapted to receive additional feedback information from the user device (27).
